(19) United States
(12) Patent Application Publication
(10) Pub. No.: US 2021/0317979 A1
(43) Pub. Date: Oct. 14, 2021

(54) AUTOMOBILE LAMP-SHADE HAVING ELECTRIC HEAT ELEMENT AND METHOD OF MAKING THE SAME

(71) Applicant: SHU-LIEN CHEN, TAICHUNG (TW)

(72) Inventor: SHU-LIEN CHEN, TAICHUNG (TW)

(21) Appl. No.: 17/219,897

(22) Filed: Apr. 1, 2021

(30) Foreign Application Priority Data
Apr. 10, 2020 (TW) 109112276

(51) Int. Cl. F21V 29/90; F21V 3/10; F21V 3/06

(52) U.S. Cl. CPC F21V 29/90; F21W 2107/10; F21V 3/062; F21V 3/10

(57) ABSTRACT

A method of making an automobile lamp-shade contains steps of: A) providing a body made of a light-transmitting material; B) providing an electric heat element; and C) adhering the electric heat element on the body. The step C) includes sub-steps of: C1) providing an electric circuit, and a detachable film made of plastic material being provided; C2) forming an adhesive film, and adhesive being coated on the surface and the electric circuit so as to form the adhesive film; and C3) adhering a release film on the adhesive film. In the step C3), the adhesive film is defined between the electric circuit and the release film, and the electric circuit is defined between the detachable film and the adhesive film. In the step C), the adhesive film is adhered on the body, and the detachable film is removed after the release film is detached.

### FIELD OF THE INVENTION

The present invention relates to an automobile lamp-shade, and more particularly to a method of making the automobile lamp-shade by which the automobile lamp-shade having an electric heat element is produced.

### BACKGROUND OF THE INVENTION

A conventional automobile lamp contains at least one light emitting element configured to emit lights via an automobile lamp-shade along a specific angle. When ambient temperature decrease greatly, moistures inside the automobile lamp freeze on an inner wall of the automobile lamp-shade facing to the light emitting element, thus influencing brightness and an emitting path of the lights.

The present invention has arisen to mitigate and/or obviate the afore-described disadvantages.

### SUMMARY OF THE INVENTION

The primary objective of the present invention is to provide a method of making an automobile lamp-shade having an electric heat element by which when electric currents flow through the electric circuit, the electric circuit is heated to increase a temperature of the body so as to avoid producing moistures on the body or to eliminate steams or snows on the body.

Another objective of the present invention is to provide an automobile lamp-shade having an electric heat element made by above-mentioned method, wherein a covering area of the electric heat element on the body is reduced so as to decrease the refraction area of the lights through the body.

To obtain above-mentioned objective, a method of making an automobile lamp-shade having an electric heat element provided by the present invention contains steps of:

A) providing a body made of a light-transmitting material;

B) providing an electric heat element; and

C) adhering the electric heat element on a side wall of the body.

The step C) includes sub-steps of:

C1) providing an electric circuit, and a detachable film made of plastic material being provided, the detachable film having a surface, and conductive material is formed on the surface so as to produce the electric circuit;

C2) forming an adhesive film, and adhesive being coated on the surface and the electric circuit so as to form the adhesive film; and

C3) adhering a release film on the adhesive film, and the adhesive film being defined between the electric circuit and the release film, and the electric circuit being defined between the detachable film and the adhesive film;

In the step C), after the release film is detached, the adhesive film is adhered on the body, and the detachable film is removed.

### BRIEF DESCRIPTION OF THE DRAWINGS

FIG. 1 is a flow chart of a method of making an automobile lamp-shade having an electric heat element according to a preferred embodiment of the present invention.

FIG. 2 is a flow chart of the sub-steps of the step C) of the method according to the preferred embodiment of the present invention.

FIG. 3 is a cross sectional view showing the assembly of an electric heat element according to the preferred embodiment of the present invention.

FIG. 4 is a rear plan view showing the assembly of a body according to the preferred embodiment of the present invention.

FIG. 5 is a cross sectional view showing the assembly of the body according to the preferred embodiment of the present invention.

### DETAILED DESCRIPTION OF THE PREFERRED EMBODIMENTS

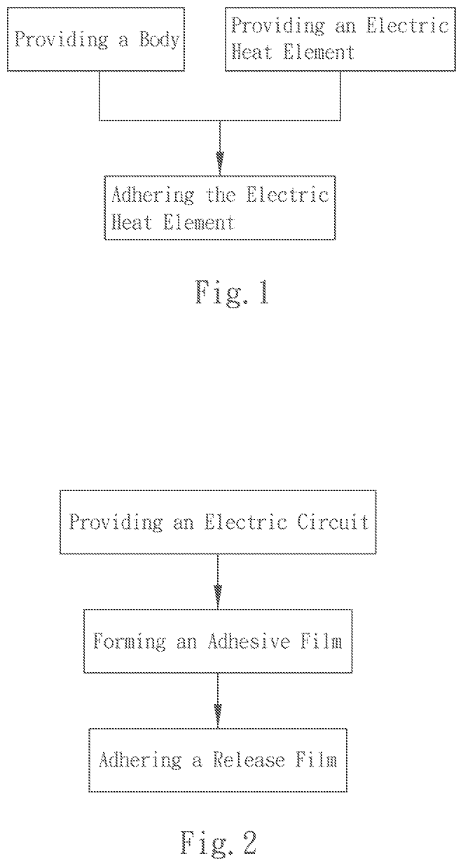

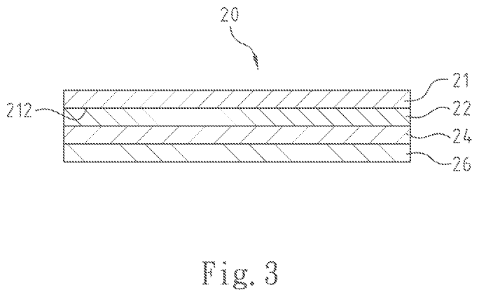

With reference to FIGS. 1-4, a method of making an automobile lamp-shade having an electric heat element according to a preferred embodiment of the present invention comprises steps of:

A) providing a body 10 of the automobile lamp-shade, wherein the body 10 is made of a light-transmitting material;

B) providing the electric heat element 20; and

C) adhering the electric heat element 20 on a side wall of the body 10.

The step C) includes sub-steps of:

C1) providing an electric circuit 22, wherein a detachable film 21 made of plastic material is provided, the detachable film 21 has a surface 212, and conductive material (such as conductive silver paste, carbon based printing ink or other metal oxides) is formed on the surface 212 in any one of a printing manner, a laser cutting manner, a cutter cutting manner, a stamping manner, and an etching manner so as to produce the electric circuit 22;

C1-1) drying, wherein the electric circuit 22 is dried when the electric circuit 22 is formed from non-solid material (such as conductive silver paste or carbon based printing ink) of the conductive material;

C2) forming an adhesive film 24, wherein adhesive is coated on the surface 212 and the electric circuit 22 so as to form the adhesive film 24; and

C3) adhering a release film 26 on the adhesive film 24, wherein the adhesive film 24 is defined between the electric circuit 22 and the release film 26, and the electric circuit 22 is defined between the detachable film 21 and the adhesive film 24;

C4) cutting, wherein after the electric circuit 22 is formed in any one of the laser cutting manner, the cutter cutting manner, and the stamping manner, a part of the detachable film 21, the adhesive film 24 and the release film 26 corresponding to the electric circuit 22 is cut, and the other part of the detachable film 21, the adhesive film 24 and the release film 26 not corresponding to the electric circuit 22 is removed, thus producing the electric heat element 201; wherein the conductive material is formed on the surface 212 in the stamping manner based on a profile of the electric circuit 22 by using a mold.

In the step C), after the release film 26 is detached, the adhesive film 24 is adhered on the body 10, and the detachable film 21 is removed.

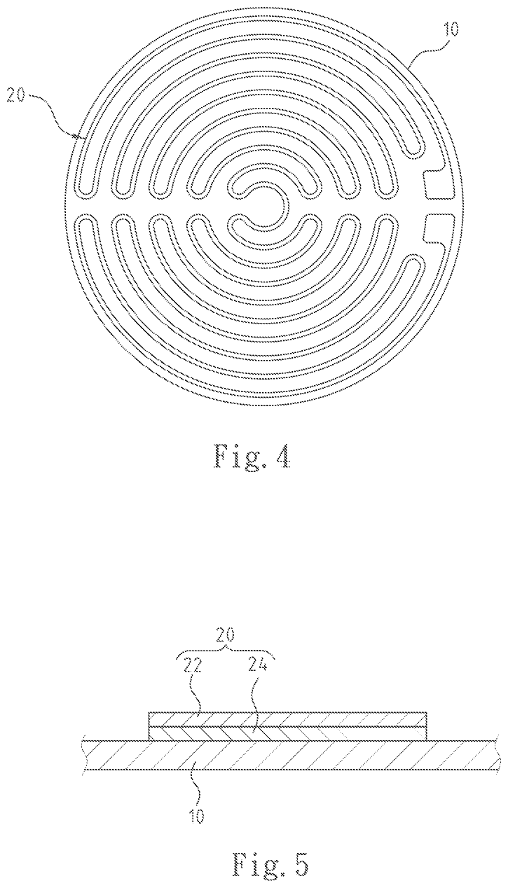

Referring to FIGS. 4 and 5, the automobile lamp-shade having the electric heat element comprises the body 10 and the electric heat element 20, wherein the body 10 is made of light-transmitting material, and the electric heat element 20 is adhered on the side wall of the body 10. The electric heat element 20 includes the electric circuit 22 and the adhesive film 24, wherein the adhesive film 24 is defined and adhered between the electric circuit 22 and the body 10.

When electric currents flow through the electric circuit 22, the electric circuit 22 is heated to increase a temperature of the body 10 so as to avoid producing moistures on the body 10 or to eliminate steams or snows on the body 10.

Preferably, after lights pass across the body 10, a refraction area of the lights through the body 10 is reduced.

In the step B), the detachable film 21, the adhesive film 24, and the release film 26 cover the electric circuit 22 so that the electric circuit 22 is not worn and damaged by the mold, when being stamped, and a profile and an area of the electric heat element 20 correspond to a profile and an area of the electric circuit 22 so that the electric heat element 20 is adhered on the body 10 to reduce a covering area of the electric heat element 20 on the body 10, thus decreasing the refraction area of the lights through the body 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of making an automobile lamp-shade having an electric heat element comprising steps of:
A) providing a body, wherein the body is made of a light-transmitting material;
B) providing an electric heat element; and
C) adhering the electric heat element on a side wall of the body;
wherein the step C) includes sub-steps of:
C1) providing an electric circuit, wherein a detachable film made of plastic material is provided, the detachable film has a surface, and conductive material is formed on the surface so as to produce the electric circuit;
C2) forming an adhesive film, wherein adhesive is coated on the surface and the electric circuit so as to form the adhesive film; and
C3) adhering a release film on the adhesive film, wherein the adhesive film is defined between the electric circuit and the release film, and the electric circuit is defined between the detachable film and the adhesive film;
wherein in the step C), after the release film is detached, the adhesive film is adhered on the body, and the detachable film is removed.

2. The method as claimed in claim 1, wherein the conductive material is formed on the surface in any one of a printing manner, a laser cutting manner, a cutter cutting manner, a stamping manner, and an etching manner.

3. The method as claimed in claim 1, wherein the electric circuit is formed from conductive silver paste.

4. An automobile lamp-shade having an electric heat made by claim 1 comprising:
a body and an electric heat element, wherein the body is made of light-transmitting material, and the electric heat element is adhered on a side wall of the body;
wherein the electric heat element includes an electric circuit and an adhesive film, wherein the adhesive film is defined and adhered between the electric circuit and the body.
